(19) United States
(12) Patent Application Publication
(10) Pub. No.: US 2025/0016496 A1
(43) Pub. Date: Jan. 9, 2025

(54) SEAT WITH SPEAKER

(71) Applicant: TOYOTA BOSHOKU KABUSHIKI KAISHA, Aichi (JP)

(72) Inventors: Masaru SAKATA, Aichi (JP); Miki KUJIME, Aichi (JP)

(73) Assignee: TOYOTA BOSHOKU KABUSHIKI KAISHA, Aichi (JP)

(21) Appl. No.: 18/746,437

(22) Filed: Jun. 18, 2024

(30) Foreign Application Priority Data
Jul. 7, 2023 (JP) 2023-112526

(51) Int. Cl. H04R 1/28; A47C 7/72; H04R 1/02

(52) U.S. Cl. CPC H04R 1/2811; A47C 7/727; H04R 1/025

(57) ABSTRACT

A seat with a speaker includes: a support part including a cushion and configured to support a body of a sitter; and a speaker unit configured to output a sound in a first direction which is one direction of out-of-plane directions of the vibrating plate, wherein: the cushion includes an accommodation hole accommodating the speaker unit; and a sound which has been outputted in a second direction opposite to the first direction among the out-of-plane directions of the vibrating plate enters a bottom surface of the accommodation hole and is absorbed in the cushion.

This Nonprovisional application claims priority under 35 U.S.C. § 119 on Patent Application No. 2023-112526 filed in Japan on Jul. 7, 2023, the entire contents of which are hereby incorporated by reference.

### TECHNICAL FIELD

The present disclosure relates to a seat with a speaker.

### BACKGROUND ART

Patent Literature 1 discloses a seat with a speaker in which a speaker unit is provided in a seat back. The speaker unit includes a flat speaker which has a rectangular plate shape and which is configured to vibrate in an out-of-plane direction to output a sound; a flat plate disposed parallel to the flat speaker; and a gap filler member which is disposed behind the flat plate and which is made of urethane foam resin.

### CITATION LIST

### Patent Literature

### [Patent Literature 1]

Japanese Patent Application Publication Tokukai No. 2020-151052

### SUMMARY OF INVENTION

### Technical Problem

When the vibrating plate of the speaker unit vibrates in an out-of-plane direction, sounds having reverse phases relative to each other are outputted on a front-surface side and a rear-surface side of the vibrating plate. The sound outputted on the rear-surface side of the vibrating plate, if travelling around to the front-surface side, interferes with the sound outputted on the front-surface e side of the vibrating plate, resulting in a possibility of deterioration in sound quality. In order to prevent the traveling-around of the sound outputted on the rear-surface side of the vibrating plate, the speaker unit may be provided with an enclosure.

However, there is a problem that when an enclosure having a sufficient volume is provided to the speaker unit provided in the seat, the speaker unit occupies much space in the seat.

It is an object of an aspect of the present disclosure to reduce a size of a structure for preventing a sound outputted on a rear-surface side of a vibrating plate from travelling around, in a speaker unit provided in a seat.

### Solution to Problem

In order to solve the foregoing problem, a seat with a speaker in accordance with an aspect of the present disclosure includes a support part including a cushion and configured to support a body of a sitter; and a speaker unit including a vibrating plate and configured to output a sound in a first direction which is one direction of out-of-plane directions of the vibrating plate, wherein: the cushion includes an accommodation hole accommodating the speaker unit; a bottom surface of the accommodation hole faces the vibrating plate; and a sound which has been outputted from the vibrating plate in a second direction opposite to the first direction among the out-of-plane directions of the vibrating plate enters the bottom surface of the accommodation hole and is absorbed in the cushion.

### Advantageous Effects of Invention

According to an aspect of the present disclosure, it is possible to further reduce a size of a structure for preventing a sound outputted on a rear-surface side of a vibrating plate from travelling around, in a speaker unit provided in a seat, than conventional ones.

### BRIEF DESCRIPTION OF DRAWINGS

FIG. 1 is a partial front view illustrating a seat with a speaker in accordance with Embodiment 1 of the present disclosure.

FIG. 2 is a front view illustrating a speaker unit included in the seat with a speaker in accordance with Embodiment 1 of the present disclosure.

FIG. 3 is an exploded perspective view illustrating the speaker unit included in the seat with a speaker in accordance with Embodiment 1 of the present disclosure.

FIG. 4 is cross-sectional view taken along line A-A of FIG. 2.

FIG. 5 is an exploded perspective view illustrating the speaker unit included in a seat with a speaker in accordance with Embodiment 2 of the present disclosure.

FIG. 6 is a cross-sectional view schematically illustrating a speaker unit included in the seat with a speaker in accordance with Embodiment 2 of the present disclosure.

FIG. 7 is a view illustrating a simulation result indicating a frequency characteristic of a sound pressure of the speaker unit included in the seat with a speaker in accordance with Embodiment 2 of the present disclosure.

FIG. 8 is a view illustrating one example of a cushion used in a seat with a speaker in accordance with Embodiment 3 of the present disclosure.

FIG. 9 is a view illustrating a variation of a cushion.

### DESCRIPTION OF EMBODIMENTS

### Embodiment 1

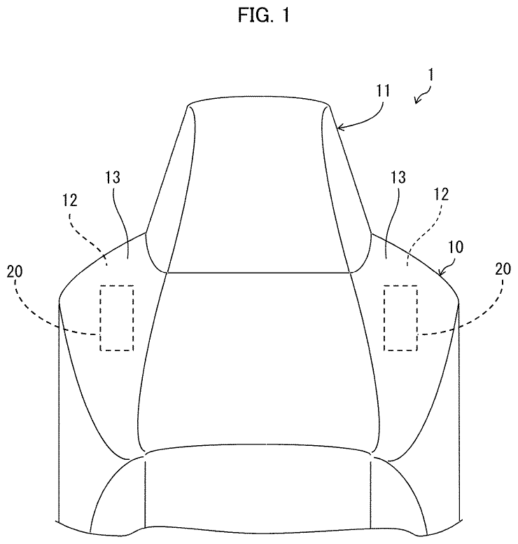

FIG. 1 is a partial front view illustrating a seat with a speaker in accordance with Embodiment 1 of the present disclosure. A seat 1 illustrated in FIG. 1 is one example of a seat with a speaker and includes a seat back 10 and a headrest 11. The seat 1 may further include, for example, a seat bottom (not illustrated) and a footrest (not illustrated), in addition to the seat back 10 and the headrest 11. The seat back 10 and the headrest 11 are each one example of a support part. The seat back 10 supports a back region of a sitter. The headrest 11 supports a rear region of the head of a sitter. The seat back 10 includes a cushion 12 and a cover 13. The cushion 12 is made of, for example, foam such as urethane and urethane chips. To the cushion 12, two speaker units 20 are fixed. The two speaker units 20 are provided so as to be able to output sounds toward the respective vicinities of the both ears of the sitter of the seat 1. The cover 13 covers the cushion 12 and the two speaker units 20. The cover 13 is made of mesh skin or perforated genuine leather and transmits the sounds which have been outputted from the speaker units 20.

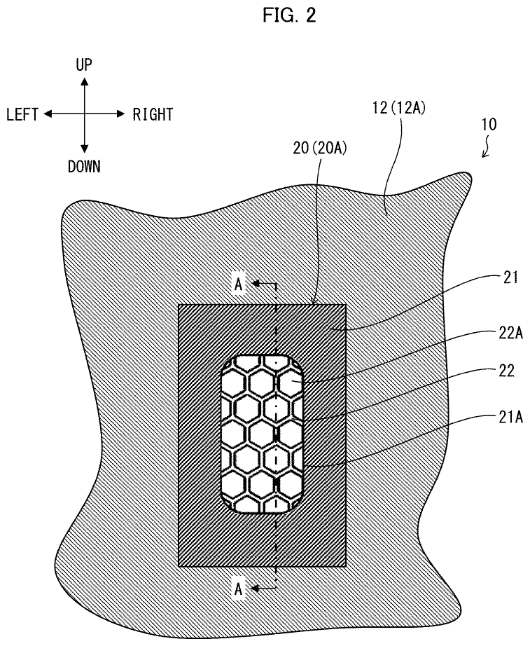

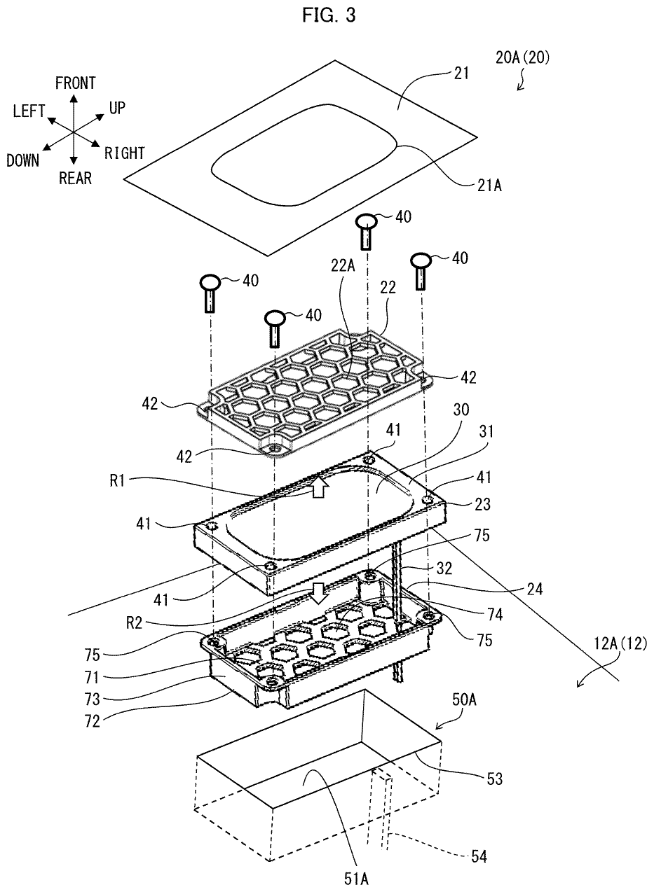

FIG. 2 is a front view illustrating a speaker unit included in the seat with a speaker in accordance with Embodiment 1 of the present disclosure. FIG. 3 is an exploded perspective view illustrating a speaker unit included in the seat with a speaker in accordance with Embodiment 1 of the present disclosure. Hereinafter, for simplification of description, an up-and-down direction, a front-and-rear direction, and a left-and-right direction of each of speaker units 20A are defined as indicated by the arrows in FIG. 2 and FIG. 3.

Each of the speaker units 20A is a speaker unit 20 in accordance with Embodiment 1 and includes a grille 22, a speaker 23, and a housing 24. A cushion 12A is a cushion 12 in accordance with Embodiment 1. As illustrated in FIG. 3, the cushion 12A has an accommodation hole 50A. The accommodation hole 50A accommodates the speaker unit 20A.

As illustrated in FIG. 3, the accommodation hole 50A has an opening 53 on a front side of the cushion 12A. The opening 53 of the accommodation hole 50A is covered with a lid part 21. The lid part 21 is made of, for example, nonwoven fabric. The lid part 21 has an area larger than that of the opening 53 of the accommodation hole 50A of the cushion 12A. The lid part 21 has an opening 21A and transmits the sound which has been outputted from the speaker unit 20. The opening 21A has an area smaller than that of the grille 22. From the opening 21A, part of the grille 22 is exposed. A periphery of the opening 21A in the lid part 21 abuts on the vicinity of an outer periphery of the accommodation hole 50A of the cushion 12A. The lid part 21 is fixed to the cushion 12A. For example, the lid part 21 is provided with a hook-and-loop fastener at a part thereof abutting on the vicinity of the outer periphery of the accommodation hole 50A and is fixed to the cushion 12A. The lid part 21 prevents the speaker unit 20 accommodated in the accommodation hole 50A from falling out of the accommodation hole 50A and fixes the speaker unit 20A to the cushion 12A.

The accommodation hole 50A is provided with a wiring hole 54. Into the wiring hole 54, a harness 32 of the speaker 23 is inserted. The speaker 23 is supplied with an electric power and a sound signal via the harness 32.

The speaker 23 of the speaker unit 20A includes a vibrating plate 30, an outer peripheral part 31, and the harness 32. The vibrating plate 30 vibrates in out-of-plane directions to output a sound. When the speaker unit 20A is accommodated in the accommodation hole 50A, the vibrating plate 30 faces a bottom surface 51A of the accommodation hole 50A and is disposed in a position spaced from the bottom surface 51A of the accommodation hole 50A. A direction on a front-surface side of the speaker 23 among the out-of-plane directions of the vibrating plate 30 is referred to as a first direction R1. In contrast, a direction opposite to the first direction R1 among the out-of-plane directions of the vibrating plate 30, that is, a direction on a rear-surface side of the speaker 23 is referred to as a second direction R2.

The grille 22 protects the vibrating plate 30 of the speaker 23. On the grille 22, a plurality of holes 22A each having a hexagonal shape are provided so as to be a honeycomb structure and transmit a sound. When the speaker unit 20A is accommodated in the accommodation hole 50A, the grille 22 is disposed between the lid part 21 and the speaker 23. The sound outputted from the vibrating plate 30 in the first direction R1 passes through the holes 22A of the grille 22 and the lid part 21 and is outputted to an outside of the seat 1.

The grille 22 has through holes 42 in the vicinities of the four corners thereof. Into the through holes 42, fastener members 40 are inserted. Examples of the fastener members 40 include screws and bolts. The outer peripheral part 31 of the speaker 23 has screw holes 41 at the four corners thereof. The fastener members 40 are inserted into the screw holes 41 of the speaker 23 via the through holes 42. This causes the grille 22 to be coupled to the speaker 23.

The housing 24 is one example of a structure. The housing 24 is disposed between the speaker 23 of the speaker unit 20A and the bottom surface 51A of the accommodation hole 50A. The housing 24 has a first surface 71 which faces the vibrating plate 30 of the speaker 23, a second surface 72 which is a back side of the first surface 71 and which is in contact with the bottom surface 51A of the accommodation hole 50A, and a leg part 73 which protrudes from an outer peripheral part of the first surface 71. The leg part 73 abuts on the outer peripheral part 31 of the speaker 23.

The housing 24 has a plurality of through holes 74 between the first surface 71 and the second surface 72. The through holes 74, for example, are holes each having a hexagonal shape and are disposed to the first surface 71 and the second surface 72 of the housing 24 so as to be a honeycomb structure. The housing 24 exhibits a lower transmittance of sound than that of the grille 22. For example, the transmittance of sound of the grille 22 is approximately 70%, and the transmittance of sound of the housing 24 is approximately 50%. The sound which has been outputted from the vibrating plate 30 of the speaker 23 in the second direction R2 passes through the through holes 74 of the housing 24, enters the bottom surface 51A of the accommodation hole 50A, and is absorbed in the cushion 12A. Therefore, the speaker unit 20A makes it possible to reduce the travelling-around of a sound.

The housing 24 is coupled to the grille 22 and the speaker 23 via the leg part 73. For example, the housing 24 has screw holes 75 and is fixed to the grille 22 and the speaker 23 with use of the fastener members 40. The coupling of the housing 24 to the grille 22 and the speaker 23 improves rigidity of the speaker unit 20A.

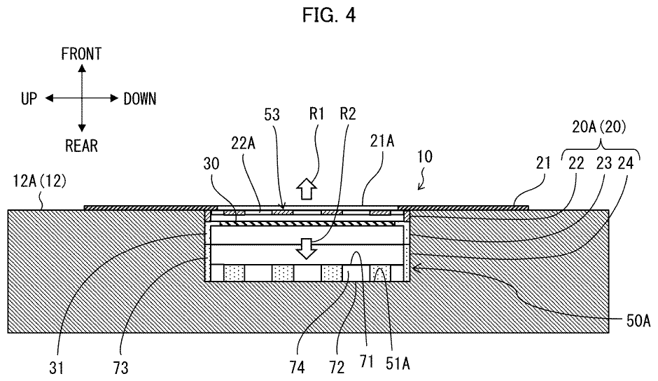

FIG. 4 is a cross-sectional view taken along line A-A of FIG. 2. Between the speaker 23 and the housing 24, a space having a size that prevents interference with a movement of the vibrating plate 30 of the speaker 23 is provided. A distance from the bottom surface 51A to the opening 53 of the accommodation hole 50A is substantially identical with a thickness in the front-and-rear direction of the grille 22, the speaker 23, and the housing 24.

### Embodiment 2

The following description will discuss another embodiment of the present disclosure. For convenience of description, a member having a function identical to that of a member discussed in the embodiment above is given an identical reference sign, and a description thereof is omitted.

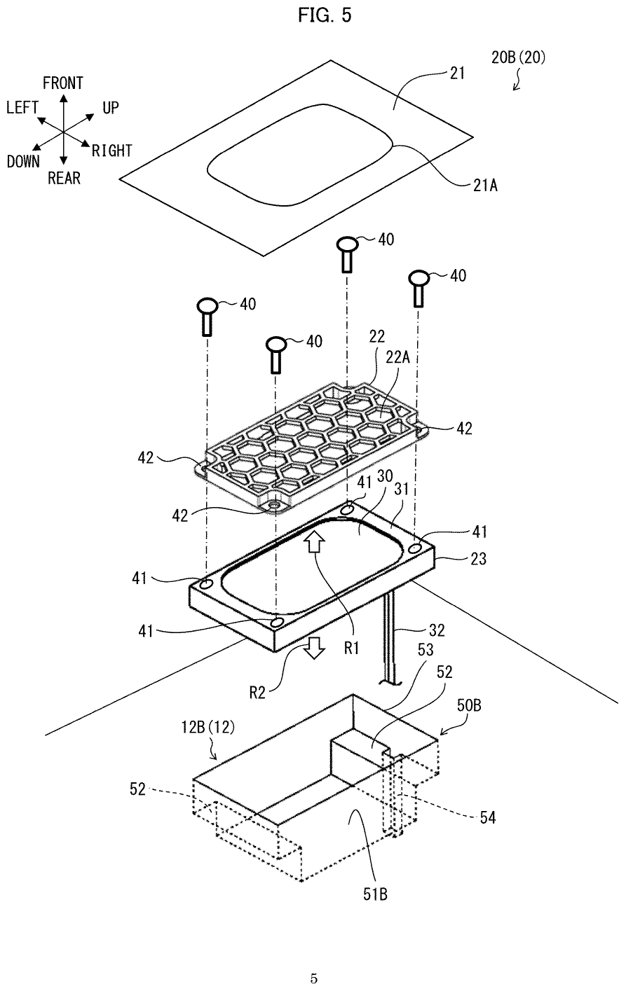

FIG. 5 is an exploded perspective view illustrating a speaker unit included in a seat with a speaker in accordance with Embodiment 2 of the present disclosure. A speaker unit 20B illustrated in FIG. 5 in accordance with Embodiment 2 of the present disclosure differs from the speaker unit 20A in accordance with Embodiment 1 in that the speaker unit 20B does not have the housing 24. Further, a cushion 12B in accordance with Embodiment 2 differs from that in accordance with Embodiment 1 in that placement stages 52 protrude from a bottom surface 51B of an accommodation hole 50B of the cushion 12B. The placement stages 52 protrude from the both ends in the up-and-down direction of the bottom surface 51B.

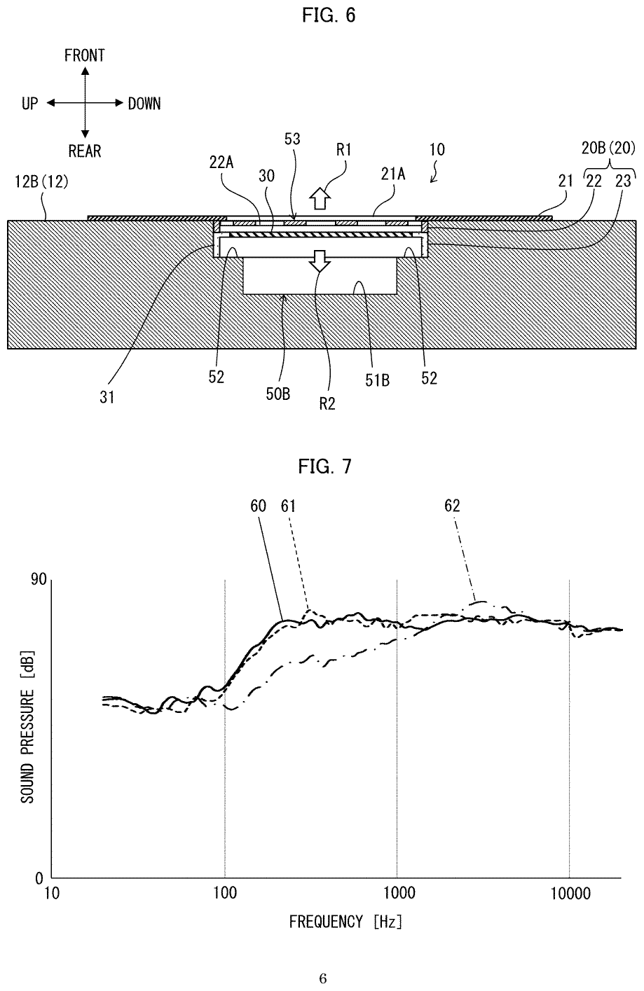

FIG. 6 is a cross-sectional view schematically illustrating a speaker unit included in the seat with a speaker in accordance with Embodiment 2 of the present disclosure. As illustrated in FIG. 6, the bottom surface 51B of the accommodation hole 50B faces the vibrating plate 30 of the speaker 23 accommodated in the accommodation hole 50B. Between the speaker 23 and the bottom surface 51B of the accommodation hole 50B, a space having a size that prevents interference with a movement of the vibrating plate 30 of the speaker 23 is provided. The sound which has been outputted from the vibrating plate 30 of the speaker 23 in the second direction R2 enters the bottom surface 51B of the accommodation hole 50B and is absorbed in the cushion 12B. Therefore, the speaker unit 20B makes it possible to reduce the travelling-around of a sound.

Further, the placement stages 52 of the accommodation hole 50B abut on the outer peripheral part 31 of the speaker 23 accommodated in the accommodation hole 50B. A length from each of the placement stages 52 to the opening 53 of the accommodation hole 50B is substantially identical with a thickness in the front-and-rear direction of the grille 22 and the speaker 23. That is, when the speaker unit 20B is accommodated in the accommodation hole 50B, the speaker unit 20B is substantially flush with the opening 53 of the accommodation hole 50B.

FIG. 7 is a view illustrating a simulation result indicating a frequency characteristic of a sound pressure of the speaker unit included in the seat with a speaker in accordance with Embodiment 2 of the present disclosure. FIG. 7 illustrates, with an actual line, a simulation result 60 indicating a relationship between a frequency of the sound outputted from the speaker unit 20B and a sound pressure of the sound. In the simulation, a volume of the space provided between the speaker 23 and the bottom surface 51B of the accommodation hole 50B was 42 cc. As comparative examples, FIG. 7 illustrates, with a dashed line, a simulation result 61 as to a speaker unit which has a 200-cc enclosure and which does not allow the cushion to absorb a sound and illustrates, with a dotted and dashed line, a simulation result 62 as to a speaker unit which has no enclosure and which does not allow the cushion to absorb a sound. As illustrated in FIG. 7, the speaker unit 20B, which occupies a smaller volume in the seat 1, makes it possible to secure sound quality equal to that of the speaker unit provided with the 200-cc enclosure.

As illustrated in FIG. 7, the speaker unit 20B in accordance with Embodiment 2 of the present disclosure exhibits a lower sound pressure in a frequency bandwidth of 1000 to 3000 Hz than the speaker unit provided with the 200—cc enclosure. The provision of the housing 24 having a predetermined transmittance between the speaker 23 and the bottom surface 51A of the accommodation hole 50A as in Embodiment 1 of the present disclosure makes it possible to adjust a sound pressure in a predetermined bandwidth.

### Embodiment 3

The following description will discuss Embodiment 3 of the present disclosure. For convenience of description, a member having a function identical to that of a member discussed in the embodiments above is given an identical reference sign, and a description thereof is omitted.

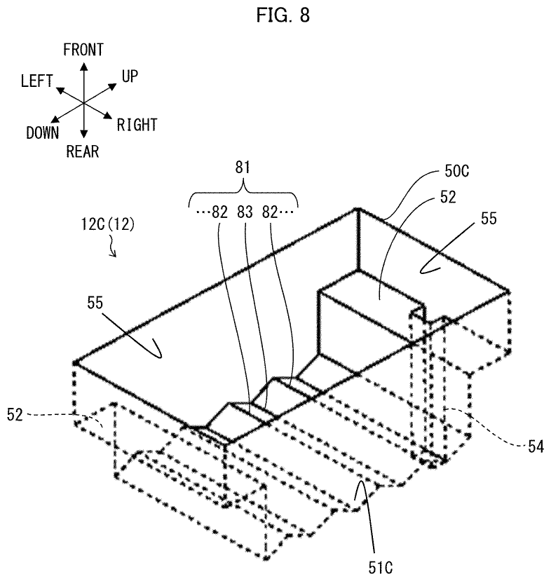

FIG. 8 is a view illustrating one example of a cushion used in a seat with a speaker in accordance with Embodiment 3 of the present disclosure. A cushion 12C in accordance with Embodiment 3 has an accommodation hole 50C. The accommodation hole 50C of the cushion 12C in accordance with Embodiment 3 differs from the accommodation hole 50B of the cushion 12B in accordance with Embodiment 2 in that a bottom surface 51C is provided with a plurality of grooves 81.

The grooves 81 are formed by alternately disposing, in the up-and-down direction, peaks 82 and valleys 83 extending in the left-and-right direction. The provision of the plurality of grooves 81 to the bottom surface 51C allows for increase of a surface area of the bottom surface 51C and enables the sound which has been outputted from the vibrating plate 30 of the speaker 23 in the second direction R2 to be absorbed more efficiently than the bottom surface 51A in accordance with Embodiment 1.

Note that the shape of each groove provided on the bottom surface 51C of the accommodation hole 50C is not limited to the shape of the groove 81 illustrated in FIG. 8. Another shape may be employed, provided that the shape enables increase of the surface area of the surface that absorbs the sound which has been outputted from the vibrating plate 30 of the speaker 23 in the second direction R2. For example, the shape of the grooves provided on the bottom surface 51C of the accommodation hole 50C may be a shape in which peaks and valleys extending in the up-and-down direction are alternately disposed in the left-and-right direction. Further, side surfaces of the grooves may each have an inclination set as appropriate or may each be a curved surface.

Furthermore, the method for increasing the surface area of the surface that absorbs the sound which has been outputted from the vibrating plate 30 of the speaker 23 in the second direction R2 is not limited only to the method for providing the grooves 81 on the bottom surface 51C. For example, holes may be provided on the bottom surface 51C of the accommodation hole 50C.

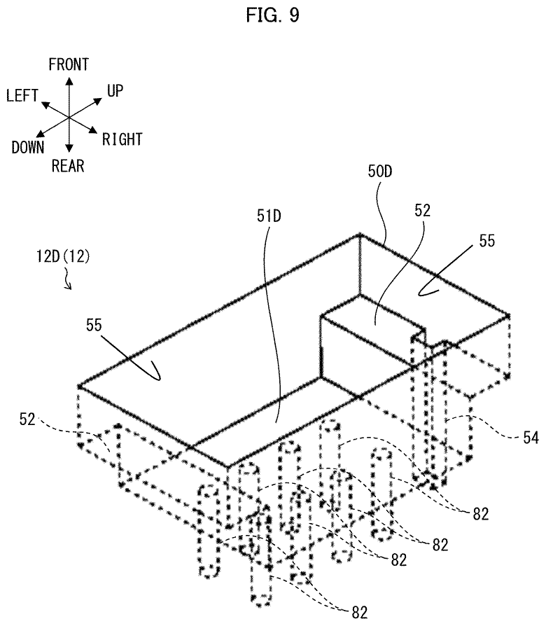

FIG. 9 is a view illustrating a variation of the cushion. A cushion 12D illustrated in FIG. 9 is provided with a plurality of holes 82 on a bottom surface 51D of an accommodation hole 50D. Note that the bottom surface 51D of the accommodation hole 50D may be provided with protrusions instead of the holes 82 or may be provided with any combination of the grooves 81, the holes 82, and the protrusions. In addition to the bottom surface 51D of the accommodation hole 50D or instead of the bottom surface 51D of the accommodation hole 50D, a side surface 55 of the accommodation hole 50D may be provided with any combination of the grooves 81, the holes 82, and the protrusions. That is, at least part of (i) the bottom surface 51D of the accommodation hole 50D and (ii) the side surface 55 of the accommodation hole 50D may be provided with any combination of the grooves 81, the holes 82, and the protrusions.

Further, the accommodation hole 50D may be provided with a rough surface on at least part of (i) the bottom surface 51D of the accommodation hole 50D and (ii) the side surface 55 of the accommodation hole 50D. Roughening at least part of (i) the bottom surface 51D of the accommodation hole 50D and (ii) the side surface 55 of the accommodation hole 50D to form a rough surface enables improvement in efficiency of absorbing the sound which has been outputted from the vibrating plate 30 of the speaker 23 in the second direction R2.

Hereinafter, the accommodation holes 50A, 50B, 50C, and 50D may be each referred to as an accommodation hole 50. The bottom surfaces 51A, 51B, 51C, and 51D may be each referred to as a bottom surface 51.

### Effects

As described above, the seat 1 includes: the seat back 10 including the cushion 12 and configured to support a body of a sitter; and each speaker unit 20 including the vibrating plate 30 and configured to output, to an outside of the seat back 10, a sound which has been outputted from the vibrating plate 30 in a first direction R1 that is one direction of out-of-plane directions of the vibrating plate 30. The cushion 12 includes the accommodation hole 50 accommodating the speaker unit 20 and having the bottom surface 51 facing the vibrating plate 30 and absorbs the sound which has been outputted form the vibrating plate 30 in the second direction R2. The cushion 12 efficiently absorbing the sound which has been outputted from the vibrating plate 30 in the second direction R2 makes it possible to further reduce a size of a structure for preventing a sound from travelling around than conventional ones. The reducing of a size of a structure for preventing a sound from travelling around makes it possible to improve a degree of flexibility for planning a design of the seat 1.

### Variations

In Embodiments 1 to 3 above, the lid part 21 is fixed to the cushion 12 with use of the hook-and-loop fastener provided at the part abutting on the vicinity of the outer periphery of the accommodation hole 50. However, the method for fixing the lid part 21 to the cushion 12 is not limited only to the hook-and-loop fastener. For example, the fixation may be achieved using, for example, an adhesive, a button, a hook, or a clip made of resin.

In Embodiments 1 to 3 above, each of the speaker units 20 is accommodated in the accommodation hole 50 of the cushion 12 and is fixed in the accommodation hole 50 by the lid part 21 fixed to the vicinity of the outer periphery of the accommodation hole 50. However, the method for fixing each speaker unit 20 is not limited only to the one using the lid part 21. For example, each of the speaker units 20 may be fixed to the placement stages 52 of the accommodation hole 50 with use of a hook-and-loop fastener.

In Embodiment 2 and Embodiment 3 above, the accommodation hole 50 is provided with the placement stages 52 at the both ends in the up-and-down direction of the bottom surface 51. However, the placement stages 52 may be provided at the both ends in the left-and-right direction of the bottom surface 51 or may be provided at the ends in both the left-and-right direction and the up-and-down direction.

In Embodiments 1 to 3 above, each of the speaker units 20 is accommodated in the cushion 12 of the seat back 10, but the cushion accommodating the speaker units 20 is not limited only to the one of the seat back 10. For example, the accommodation hole 50 may be alternatively provided in the cushion of the headrest 11 and accommodate the speaker unit 20.

In Embodiments 1 to 3 above, the speaker units 20 are configured to output sounds to the vicinities of the both ears of a sitter of the seat 1. However, the direction in which the sounds are outputted is not limited to this. For example, the sounds may be outputted towards a sitter seated on a seat behind the seat 1. In a case where the sounds are outputted toward the sitter seated on the seat behind the seat 1, the cushion 12 may be provided with the accommodation holes 50A, 50B, 50 C, or 50D on a rear-surface side and be provided with the grilles 22 and the speakers 23 of the speaker units 20 therein.

In Embodiments 1 to 3, the cushion 12 is made of foam, such as urethane and urethane chips. However, the material of the cushion 12 is not limited only to the foam. For example, the cushion 12 may be made of three-dimensional network structured fiber material in which elastic fibers are connected with each other so as to be a structure having a form of a three-dimensional network.

In Embodiment 1 above, the leg part 73 of the housing 24 protrudes from the entire outer peripheral part of the first surface 71, as illustrated in FIG. 3. However, the leg part 73 of the housing 24 does not necessarily protrude from the entire outer peripheral part of the first surface 71. Partial absence of the leg part 73 causes part of the sound that has been reflected on the housing 24 to enter the side surface of the cushion 12A and be absorbed in the cushion 12A. This makes it possible to reduce the travelling-around of the sound.

In Embodiments 1 to 3 above, the holes 22A of the grille 22 and the through holes 74 of the housing 24 are achieved by disposing holes each having a hexagonal shape so as to be a honeycomb structure. However, this should not be construed as a limitation. For example, the holes 22A and the through holes 74 may be achieved by disposing holes each having a rectangular shape so as to be a lattice structure.

### Additional Remarks

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

Aspects of the present invention can also be expressed as follows:

A seat with a speaker in accordance with Aspect 1 of the present disclosure includes a support part including a cushion and configured to support a body of a sitter; and a speaker unit including a vibrating plate and configured to output a sound in a first direction which is one direction of out-of-plane directions of the vibrating plate, wherein: the cushion includes an accommodation hole accommodating the speaker unit; a bottom surface of the accommodation hole faces the vibrating plate; and a sound which has been outputted from the vibrating plate in a second direction opposite to the first direction among the out-of-plane directions of the vibrating plate enters the bottom surface of the accommodation hole and is absorbed in the cushion.

According to the above configuration, the bottom surface of the accommodation hole of the cushion faces the vibrating plate, and the sound which has been outputted from the vibrating plate in the second direction enters the bottom surface of the accommodation hole and is absorbed in the cushion. This enables the cushion to efficiently absorb the sound and makes it possible to reduce a size of a structure for preventing the sound from travelling around.

A seat with a speaker in accordance with Aspect 2 of the present disclosure is configured, in the seat with a speaker in accordance with Aspect 1 above, to further include a structure including a first surface which faces the vibrating plate, a second surface which is a back side of the first surface, a leg part which protrudes from an outer periphery of the first surface, and through holes between the first surface and the second surface, wherein: the structure is coupled to the speaker unit via the leg part; the second surface is in contact with the bottom surface of the accommodation hole; and the sound which has been outputted from the vibrating plate in the second direction passes through the through holes, enters the bottom surface of the accommodation hole, and is absorbed in the cushion.

According to the above configuration, the seat with a speaker further includes a structure which is coupled to the speaker unit via the leg part protruding from the first surface, which has the second surface that is a back side of the first surface and that is in contact with the bottom surface of the accommodation hole, and in which through holes are provided between the first surface and the second surface. Providing such a structure makes it possible to improve rigidity of the speaker unit.

A seat with a speaker in accordance with Aspect 3 of the present disclosure is configured, in the seat with a speaker in accordance with Aspect 1 or 2 above, to further include a lid part that transmits the sound which has been outputted from the vibrating plate in the first direction and that is fixed to the cushion, the lid part covering the accommodation hole.

According to the above configuration, the lid part covers the accommodation hole accommodating the speaker unit, and the lid part is fixed to the cushion. This makes it possible to prevent the speaker unit from falling out of the accommodation hole.

A seat with a speaker in accordance with Aspect 4 of the present disclosure is configured, in the seat with a speaker in accordance with Aspect 1 above, such that the cushion includes a placement stage abutting on an outer periphery of the speaker unit and protruding from the bottom surface of the accommodation hole.

According to the above configuration, the cushion includes the placement stage abutting on the outer periphery of the speaker unit and protruding from the bottom surface of the accommodation hole. This allows a space to be secured between the speaker unit and the bottom surface of the accommodation hole and makes it possible to prevent bottom the surface of the accommodation hole from interfering with the vibrating plate in deformation of the cushion.

A seat with a speaker in accordance with Aspect 5 of the present disclosure is configured, in the seat with a speaker in accordance with Aspect 4 above, such that the speaker unit is fixed to the placement stage.

According to the above configuration, the speaker unit is fixed to the placement stage of the accommodation hole of the cushion. This makes it possible to fix the speaker unit to the seat with a speaker with use of the reduced number of components.

A seat with a speaker in accordance with Aspect 6 of the present disclosure is configured, in the seat with a speaker in accordance with Aspect 1 above, such that at least one selected from the group consisting of a groove, a hole, and a protrusion is formed on at least part of (i) the bottom surface of the accommodation hole and (ii) a side surface of the accommodation hole.

According to the above configuration, at least one selected from the group consisting of a groove, a hole, and a protrusion is formed on at least part of (i) the bottom surface of the accommodation hole and (ii) the side surface of the accommodation hole. This enables the cushion to efficiently absorb the sound which has been outputted from the vibrating plate in the second direction.

A seat with a speaker in accordance with Aspect 7 of the present disclosure is configured, in the seat with a speaker in accordance with Aspect 1 above, such that at least part of (i) the bottom surface of the accommodation hole and (ii) a side surface of the accommodation hole has a rough surface.

According to the above configuration, at least part of (i) the bottom surface of the accommodation hole and (ii) the side surface of the accommodation hole has a rough surface. This enables the cushion to efficiently absorb the sound which has been outputted from the vibrating plate in the second direction.

A seat with a speaker in accordance with Aspect 8 of the present disclosure is configured, in the seat with a speaker in accordance with Aspect 1 above, such that the cushion is made of foam or three-dimensional network structured fiber material.

The above configuration enables the cushion to absorb the sound which has been outputted from the vibrating plate in the second direction. Further, the cushion is enabled to be easily provided with the accommodation hole.

### REFERENCE SIGNS LIST

1 Seat
10 Seat back
11 Headrest
12, 12A, 12B, 12C, 12D Cushion
20, 20A, 20B Speaker unit
21 Lid part
22 Grille
23 Speaker
24 Housing
30 Vibrating plate
31 Outer peripheral part
50, 50A, 50B, 50C, 50D Accommodation hole
51, 51A, 51B, 51C, 51D Bottom surface
52 Placement stage
54 Wiring hole
55 Side surface
73 Leg part
R1 First direction
R2 Second direction

1. A seat with a speaker, the seat comprising:
a support part including a cushion and configured to support a body of a sitter; and
a speaker unit including a vibrating plate and configured to output a sound in a first direction which is one direction of out-of-plane directions of the vibrating plate, wherein:
the cushion includes an accommodation hole accommodating the speaker unit;
a bottom surface of the accommodation hole faces the vibrating plate; and
a sound which has been outputted from the vibrating plate in a second direction opposite to the first direction among the out-of-plane directions of the vibrating plate enters the bottom surface of the accommodation hole and is absorbed in the cushion.

2. The seat with a speaker according to claim 1, the seat further comprising a structure including a first surface which faces the vibrating plate, a second surface which is a back side of the first surface, a leg part which protrudes from an outer periphery of the first surface, and a through hole between the first surface and the second surface, wherein:
the structure is coupled to the speaker unit via the leg part;
the second surface is in contact with the bottom surface of the accommodation hole; and
the sound which has been outputted from the vibrating plate in the second direction passes through the through hole, enters the bottom surface of the accommodation hole, and is absorbed in the cushion.

3. The seat with a speaker according to claim 1, the seat further comprising a lid part that transmits the sound which has been outputted from the vibrating plate in the first direction and that is fixed to the cushion, the lid part covering the accommodation hole.

4. The seat with a speaker according to claim 1, wherein the cushion includes a placement stage abutting on an outer periphery of the speaker unit and protruding from the bottom surface of the accommodation hole.

5. The seat with a speaker according to claim 4, wherein the speaker unit is fixed to the placement stage.

6. The seat with a speaker according to claim 1, wherein at least one selected from the group consisting of a groove, a hole, and a protrusion is formed on at least part of (i) the bottom surface of the accommodation hole and (ii) a side surface of the accommodation hole.

7. The seat with a speaker according to claim 1, wherein at least part of (i) the bottom surface of the accommodation hole and (ii) a side surface of the accommodation hole has a rough surface.

8. The seat with a speaker according to claim 1, wherein the cushion is made of foam or three-dimensional network structured fiber material.
